(19) United States
(12) Patent Application Publication
(10) Pub. No.: US 2016/0338535 A1
(43) Pub. Date: Nov. 24, 2016

(54) CHARCOAL GRILL

(71) Applicant: TEPRO Garten GmbH, Roedermark (DE)

(72) Inventor: Carsten Witsch, Aachen (DE)

(21) Appl. No.: 15/156,505

(22) Filed: May 17, 2016

(30) Foreign Application Priority Data
May 19, 2015 (DE) 102015107796.5

(51) Int. Cl. A47J 37/07

(52) U.S. Cl. CPC A47J 37/0786; A47J 2037/0795

(57) ABSTRACT

A charcoal grill (1) includes a housing (5), which forms a first pair (3) of opposing side walls (2) and a second pair (4) of opposing side walls, a charcoal receptacle (6) arranged in the housing (5) and a cooking grid (7) having a handle (8) that protrudes beyond the housing. An a first distance is provided between the charcoal receptacle (6) and the cooking grid (7) with direct or indirect support of the cooking grid (7) on supporting sections (9) formed by the first pair (3) of side walls (2). A second distance between the charcoal receptacle (6) and the cooking grid (7) is predetermined by supporting sections (9) formed by the second pair (4) of side walls (2), so that the distance between the charcoal receptacle (6) and the cooking grid (7) can be adjusted by realignment of the cooking grid (7) and placing the cooking grid (7) on the supporting sections (9) of the other pair (3, 4) of side walls (2).

### CROSS-REFERENCE TO RELATED APPLICATIONS

The instant application claims the priority date of May 19, 2015, the filing date of the German patent application DE 10 2015 107 796.5.

### BACKGROUND OF THE INVENTION

The present invention relates to a charcoal grill with a housing, comprising a first pair of opposing side walls and a second pair of opposing side walls, a charcoal receptacle arranged in the housing and a cooking grid that protrudes beyond the housing with at least one handle and has an area for the food to be grilled, wherein a first distance is provided between the charcoal receptacle and the cooking grid by directly or indirectly laying the cooking grid on supporting sections formed by the first pair of side walls.

In charcoal grills, it is desirable for the distance between the burning charcoals in the charcoal receptacle and the food to be grilled on the cooking grid to be variable, so that the heat acting on the food to be grilled can be varied. To do so, it is known that the cooking grid inserted into a group of recesses formed on a carrier part with holding regions, for example, is removed to adjust the distance from the charcoals to the group of recesses and is inserted into a group of recesses arranged above or below the carrier part, while retaining the alignment of the cooking grid. In the case of a cooking grid covered completely with food to be grilled in particular, it becomes tedious to remove the cooking grid from the recesses and insert the cooking grid into the recesses.

A charcoal grill having the features defined in the introduction is known from DE 2 716 521 A1, wherein the cooking grid with its area for food to be grilled can be placed directly on the side walls of the housing. Due to the placement of the area for food to be grilled on the side walls, the side walls become soiled, so that the side walls must also be cleaned after each grilling operation. U.S. Pat. No. 3,841,298 A, U.S. Pat. No. 3,395,691 A and US Patent 2008/0087176 A1 each disclose additional charcoal grills.

### SUMMARY OF THE INVENTION

The object of the present invention is therefore to overcome the disadvantages described with respect to the state of the art and in particular to provide a charcoal grill that will become soiled to a lesser extent.

The object is achieved in particular by a charcoal grill having the features defined above, wherein the cooking grid has at least two handles, each being connected by means of at least one connecting strut to the area for grilling food, and there is a second distance between the charcoal receptacle and the cooking grid due to supporting sections formed by the second pair of side walls, these supporting sections being offset in the vertical direction relative to the supporting sections formed on the first pair of side walls, so that the distance between the charcoal receptacle and the cooking grid can be varied by realignment of the cooking grid and by placing the cooking grid with the connecting struts on the supporting sections of the other pair of side walls.

Supporting sections corresponding to opposing side walls are formed on each side wall of a pair, which is where the cooking grid is placed. The side walls are designed to be flat in particular, wherein the side walls of a pair of side walls are aligned in parallel to one another in particular. The at least one supporting section of each side wall is formed on an upper edge of the corresponding side wall in particular. The first pair of corresponding supporting sections formed on the first pair of side walls is offset in the vertical direction from the second pair of corresponding supporting sections formed on the second pair of side walls. The cooking grid, which is initially placed on the first pair of supporting sections, will be lifted to change the distance from the charcoal receptacle, i.e., preferably lifted up from the first pair of supporting sections and rotated in the plane of the cooking grid and then placed on the second pair of supporting sections on the second pair of side walls. The distance between the cooking grid and the charcoal receptacle can thus be adjusted easily.

The opposing side walls are in particular flat and arranged parallel to one another, so that the housing of the charcoal grill has a polygonal cross section with an even number of side walls. The cooking grid preferably has an area for the food to be grilled, which is preferably shaped in accordance with the cross-sectional shape of the housing and protrudes beyond the housing at the sides with the handles in particular. The cooking grid is placed on the supporting sections of the side walls with the connecting struts formed between the handles and the area for the food to be grilled. The supporting sections are formed by the side walls, in particular on the upper edge of the respective side wall, which means that the cooking grid can be placed on the supporting sections only by a vertical movement after being aligned above the housing. Therefore, it is not necessary for the cooking grid to be moved linearly in a horizontal direction when placed on the supporting sections. To change the distance, one need only raise the cooking grid and turn it in the plane of the cooking grid and then lower it. Notches or elevations are preferably formed on the upper edge of the side walls to raise the supporting sections for the cooking grid and secure the cooking grid when it is placed in its position.

The cooking grid can be placed directly on the supporting sections of the opposing side walls with no additional elements between the supporting sections and the cooking grid. Alternatively, however, it is possible to provide for one element each to be arranged between the supporting sections of opposing side walls and the cooking grid, so that the cooking grid rests on the supporting sections only indirectly with a vertical offset.

The charcoal receptacle may be arranged inseparably in a predetermined position on the housing. Alternatively, it is possible to provide for the charcoal receptacle to have holding elements, which are arranged with an offset vertically from a charcoal receptacle area and with which the charcoal receptacle rests on the supporting sections formed by the first pair of side walls, so that the cooking grid in turn can be placed directly on the holding elements of the charcoal receptacle. This also means that the distance between the cooking grid and the charcoal receptacle area of the charcoal receptacle is determined by the vertical distance between the holding element and the charcoal receptacle. Preferably, however, corresponding recesses are formed in the holding elements with the indentations in the side walls, so that the cooking grid sits directly on the side walls in the notches in the area of the recesses. Such a design has the advantage that the charcoal receptacle suspended with the holding elements on the side walls is also placed only on the supporting sections and therefore can be removed easily from the charcoal grill for removal of the ash.

In one embodiment of the charcoal grill, it is possible to provide that a cover can be fastened releasably on the housing, so that the charcoal grill can be carried by a carrier handle formed on the cover when the cover is attached to the charcoal grill. Such a releasable attachment of the cover to the housing can be implemented in particular by a tension strap closure, which is fastened on the housing and engages in a fastening region on the cover. Even if the charcoal grill still has a slightly elevated temperature for a while after grilling, it is still easy to achieve portability of the charcoal grill by means of such a releasable fastening of the cover to the carrier handle.

To achieve simple assembly of the charcoal grill, it is possible to provide that the housing is designed in multiple parts, and one housing part is formed completely with each side wall and the adjacent side walls are each formed only partially, in particular halfway. The housing parts in this case are fastened to one another with the regions forming only a portion of the side walls.

In a preferred embodiment, it is provided that the housing has a rectangular cross section, preferably a square cross section. In this case, the area of the cooking grid for food to be grilled preferably has a rectangular shape and/or a square shape, wherein the area for the food to be grilled in particular is arranged on the supporting section inside the housing formed by the side walls, while the cooking grid rests on the supporting sections.

It is possible to provide for the housing parts forming the side walls to form legs in one piece for setting up the charcoal grill. This makes it possible to implement a very compact charcoal grill because additional part need not be provided for the legs. Such a compact charcoal grill is in particular easy to transport and can therefore be carried along easily to any grilling site.

### BRIEF DESCRIPTION OF THE DRAWINGS

The invention and the technical environment are explained below on the basis of the figures as examples, wherein it should be pointed out that the figures show a preferred embodiment of the invention, although it is not limited to this embodiment. In the figures:

FIG. 1 shows an exploded view of a charcoal grill;

FIG. 2 shows a charcoal grill with a first distance between the cooking grid and the charcoal receptacle;

FIG. 3 shows the charcoal grill according to FIG. 1 with a second distance between the cooking grid and the charcoal receptacle; and

FIG. 4 shows the charcoal grill according to FIG. 1 with a cover releasably attached to a housing.

### DETAILED DESCRIPTION OF THE PREFERRED EMBODIMENTS

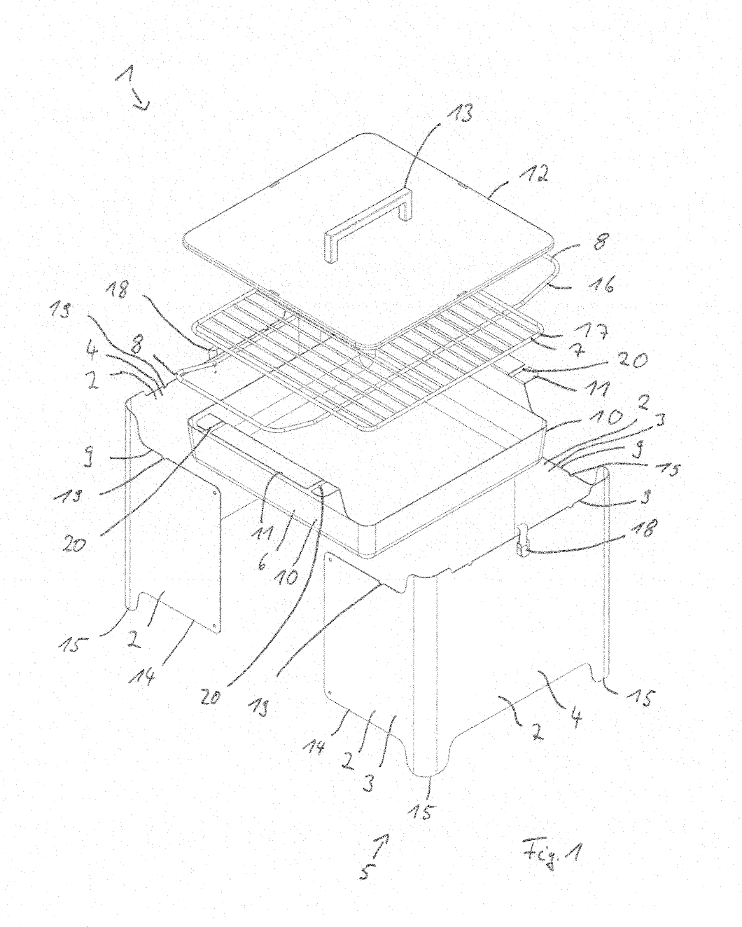

The figures show a charcoal grill 1, and FIG. 1 shows an exploded view of the charcoal grill 1. The charcoal grill 1 includes a housing 5, which consists of two housing parts 14. The housing 5 formed by the housing parts 14 has a first pair 3 of opposing side walls 2 and a second pair 4 of opposing side walls 2. A supporting section 9 with notches 19 is formed on an upper side edge of each side wall 2. Two legs 15 are formed on each lower edge in the corner areas of the housing parts 14.

The charcoal grill 1 also includes a charcoal receptacle 6 with a charcoal receiving area 10 and holding elements 11. The holding elements 11 can be placed on supporting sections 9 of opposing side walls 2, so that the charcoal receiving area 10 is suspended in the housing 5. The holding elements 11 have recesses 20, which correspond to the notches 19 in the respective side wall 2.

Furthermore, the charcoal grill 1 includes a cooking grid 7 with handles 8 protruding laterally beyond the housing 5. The handles 8 are connected by means of connecting struts 16 to an area 17 of the cooking grid 7 for food to be grilled.

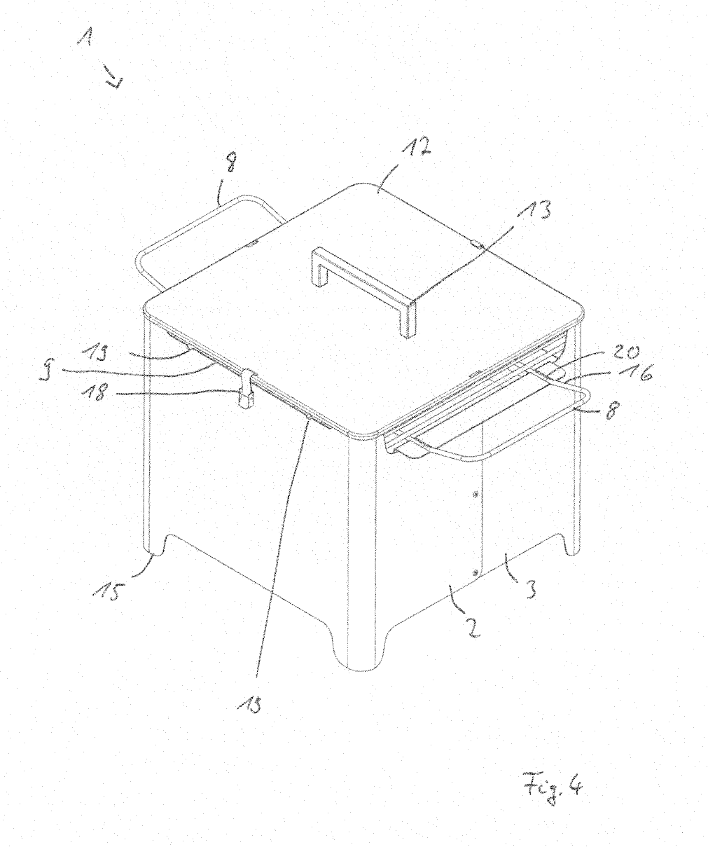

The charcoal grill 1 also includes a cover 12 with a carrying handle 13, which can be releasably attached to the housing 5 by means of tension strap closures 18 mounted on the side walls 2 (see FIG. 4). For transporting the charcoal grill 1, the cover 12 can thus be fastened onto the housing 5 easily by means of the tension strap closures 18.

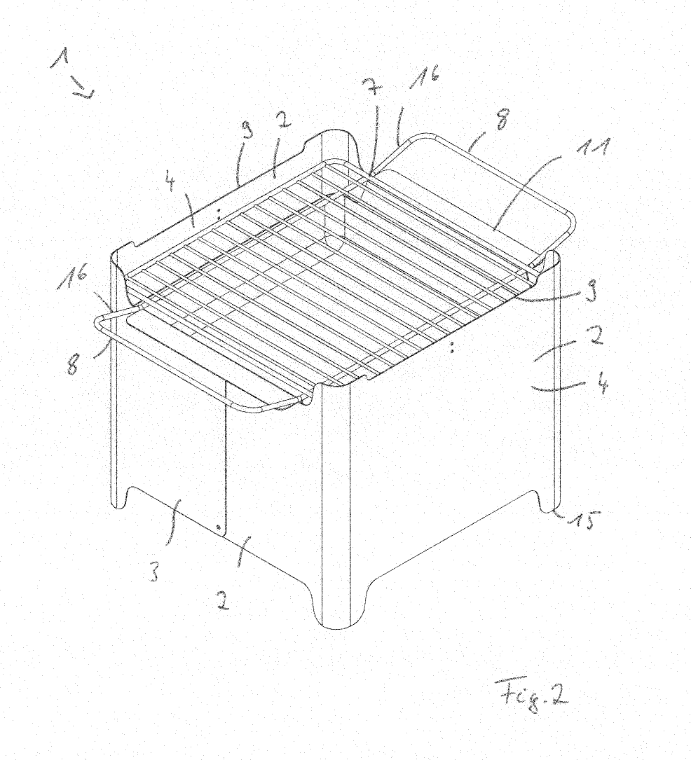

In the embodiment shown in FIG. 2, the charcoal receptacle 6 with the holding elements 11 sits on the supporting sections 9 formed on an upper edge of the first group 3 of side walls 2. The cooking grid 7 is in turn resting with the connecting struts 16 on the holding elements 11 of the charcoal receptacle 6 and thus rests indirectly on the supporting sections 9. In the embodiment in FIGS. 1, 3 and 4, recesses 20 are formed in the holding elements 11, through which the cooking grid 7 is inserted into the notches 19 in the supporting sections 9 of the side walls 2. In this position, the distance between the area 17 of the cooking grid 7 for the food to be grilled and the charcoal receiving area 10 of the charcoal receptacle 6 has a first value.

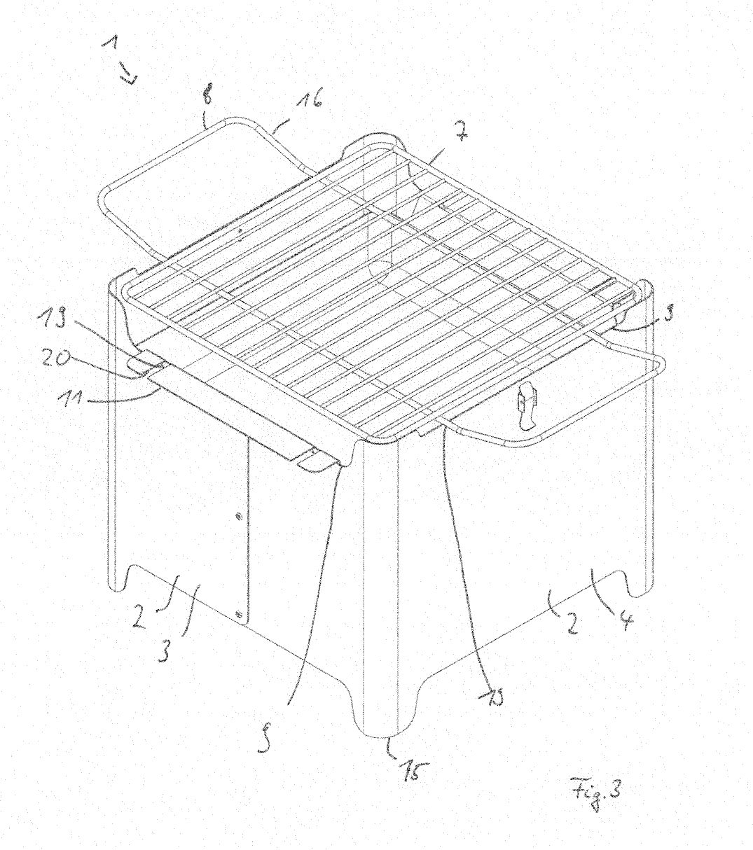

To increase the distance between the area 17 of the cooking grid 7 for the food to be grilled and the charcoal receiving area 10 of the charcoal receptacle 6, the cooking grid 7 is raised and rotated by 90° in its plane and then placed back again on the second pair 4 of side walls 2 on the supporting sections 9. According to the embodiment in FIGS. 1, 3 and 4, the supporting sections 9 of the side walls 2 have notches 19 on an upper edge of the side walls 2, into which the cooking grid 7 with the connecting struts 16 is inserted. Such a second position is illustrated in FIG. 3. A change in the distance between the cooking grid 7 and the glowing charcoal is thus easy to implement.

The specification incorporates by reference the disclosure of DE 10 2015 107 796.5, filed May 19, 2015.

The present invention is, of course, in no way restricted to the specific disclosure of the specification and drawings, but also encompasses any modifications within the scope of the appended claims.

### REFERENCE NUMERAL LISTING

1 charcoal grill
2 side wall
3 first pair
4 second pair
5 housing
6 charcoal receptacle
7 cooking grid
8 handle
9 supporting section
10 charcoal receiving area
11 holding element
12 cover
13 carrying handle
14 housing part
15 leg
16 connecting struts
17 area for food to be grilled
18 tension strap closure
19 notch
20 recess

1. A charcoal grill (1), comprising:
a housing (5), including a first pair (3) of opposing side walls (2) and a second pair (4) of opposing side walls (2);
a charcoal receptacle (6) arranged in the housing (5); and
a cooking grid (7) having at least one handle (8) protruding beyond the housing (5) and having an area (17) for food to be grilled,
wherein a first distance is defined between the charcoal receptacle (6) and the cooking grid (7) by directly or indirectly laying the cooking grid (7) on supporting sections (9) formed by the first pair (3) of side walls (2),
wherein the cooking grid (7) has at least two handles (8) connected to the area (17) for grilling food via at least one connecting strut (16), and wherein a second distance between the charcoal receptacle (6) and the cooking grid (7) is predefined by supporting sections (9) formed by the second pair (4) of side walls (2), wherein said supporting sections are offset in the vertical direction from the supporting sections (9) formed on the first pair (3) of side walls (2), so that the distance between the charcoal receptacle (6) and the cooking grid (7) is adjustable by realignment of the cooking grid (7) and placement of the cooking grid (7) with the connecting struts (16) on the supporting sections (9) of the other pair (3, 4) of side walls (2).

2. The charcoal grill (1) according to claim 1, wherein the charcoal receptacle (6) has holding elements (11) arranged with an offset vertically from a charcoal receiving area (10), wherein the charcoal receptacle (6) rests on supporting sections (9) formed by the first pair (3) of side walls (2) with said holding elements (11), wherein the cooking grid (7) can be placed directly on the holding elements (11) of the charcoal receptacle (6).

3. The charcoal grill (1) according to claim 1, wherein a cover (12) is releasably attachable to the housing (5), so that the charcoal grill (1) is supportable on a carrying handle (13) formed on the cover (12) when the cover (12) is attached to the charcoal grill (1).

4. The charcoal grill (1) according to claim 1, wherein the housing (5) has multiple housing parts, and one of said housing parts (14) completely forms a side wall (2) and forms each of the adjacent side walls (2) only partially.

5. The charcoal grill (1) according to claim 4, wherein said one of said housing parts (14) forms half of each of the adjacent side walls (2).

6. The charcoal grill (1) according to claim 1, wherein the housing (5) has a rectangular cross section.

7. The charcoal grill (1) according to claim 6, wherein the housing (5) has a square cross section.

8. The charcoal grill (1) according to claim 1, wherein the housing parts (14) forming the side walls (2) form legs (15) for the charcoal grill (1) to stand on.
